(19) United States
(12) Patent Application Publication
(10) Pub. No.: US 2026/0147200 A1
(43) Pub. Date: May 28, 2026

(54) HIGH THROUGHPUT OPTICAL IMAGER

(71) Applicant: Standard BioTools Inc., South San Francisco (CA)

(72) Inventors: Daaf Sandkuijl, Markham (CA); Alexander V. Loboda, Thornhill (CA)

(73) Assignee: Standard BioTools Inc., South San Francisco (CA)

(21) Appl. No.: 19/114,609

(22) PCT Filed: Nov. 3, 2023
(86) PCT No.: PCT/US2023/036777

§ 371 Date: Mar. 24, 2025

Related U.S. Application Data
(60) Provisional application No. 63/422,107, filed on Nov. 3, 2022.

(51) Int. Cl. G02B 21/36; G02B 21/08; G02B 21/12; G02B 21/16; H04N 23/55

(52) U.S. Cl. CPC G02B 21/361; G02B 21/088; G02B 21/125; G02B 21/16; H04N 23/55

(57) ABSTRACT

In various aspects, microscope systems are described, comprising or corresponding to optical microscopes, such as for example a transillumination microscope or a fluorescence microscope. The microscope systems may be used independently or configured with or integrated into another device or system, such as an imaging mass spectrometer or imaging mass cytometer. In various embodiments of this aspect, the microscope system is used to obtain one or more images of a sample, such as at a variety of different light collection wavelengths and/or for a variety of different illumination conditions. The microscope systems can employ various optical components and configurations allowing for high throughput imaging, such as components for imaging the sample at suitable resolutions with a wide field of view and/or for spatially separating different detection channel wavelengths from light output (e.g., transmitted or emitted light) from the sample.

### CROSS-REFERENCE TO RELATED APPLICATIONS

This application claims the benefit of and priority to U.S. Provisional Application No. 63/422,107, filed Nov. 3, 2022, the entire contents of which are incorporated herein by reference for all purposes.

### FIELD

The inventions relate generally to optical microscope systems and related techniques for high throughput imaging.

### BACKGROUND

One challenge in achieving both high throughput and high parameter count in fluorescence imaging is to find ways to effectively parallelize the data acquisition. In the case of fluorescence imaging, the spatial dimensions require much higher resolutions (e.g., on the order of 1000 pixels per spatial dimension) than the spectral dimension (e.g., 5-30 channels). Fluorescence and bright field imaging systems can generally collect data from a large area simultaneously with 2D image sensors, but may take more time to acquire more spectral dimensions, thereby impacting sample throughput.

### SUMMARY

In various aspects, microscope systems are described, comprising or corresponding to optical microscopes, such as for example a transillumination microscope or a fluorescence microscope. The microscope systems may be used independently or configured with or integrated into another device or system, such as an imaging mass spectrometer or imaging mass cytometer. In various embodiments of this aspect, the microscope system is used to obtain one or more images of a sample, such as at a variety of different light collection wavelengths and/or for a variety of different illumination conditions. The microscope systems can employ various optical components and configurations allowing for high throughput imaging, such as components for imaging the sample at suitable resolutions with a wide field of view and/or for spatially separating different detection channel wavelengths from light output (e.g., scattered or emitted light) from the sample.

The obtained images can comprise a multispectral dataset, which can be subjected to spectral unmixing to allow for identification of various tags or labels (e.g., fluorophores or chromophores) in the sample and to determine a spatial abundance of the various tags or labels in the sample. The images can also be used to identify regions of interest of the sample for further processing or interrogation. In various embodiments, the microscope systems are used to non-destructively identify sample components, such as a cell or sub-cellular structures, and locations, which can then be subjected to other (e.g., destructive) techniques such as mass spectrometry or mass cytometry. For example, individual cells can be extracted from a cell smear sample and then sent for DNA and protein analysis using various single cell deep profiling techniques including link probing of proteins. In another example, a region of interest on tissue can be extracted utilizing laser capture microdissection and then studied for deep profiling on the region-by-region basis. In various embodiments, deep profiling of regions is accomplished via microfluidic based technologies.

In another aspect, methods are described comprising or corresponding to microscopy techniques for imaging samples, such as using transillumination microscopy techniques or fluorescence microscopy techniques. Aspects of the disclosed methods can generate multispectral data sets, as described above, and may include spectral unmixing processes to determine a spatial distribution and abundance of tags or labels in the samples.

The disclosed methods and systems may in various embodiments comprise or employ autofocusing techniques and systems, which can allow for generation of good quality, in-focus images by adjusting a position of the sample to provide a suitable image of the sample on a photosensor.

Without wishing to be bound by any particular theory, there can be discussion herein of beliefs or understandings of underlying principles relating to the invention. It is recognized that regardless of the ultimate correctness of any mechanistic explanation or hypothesis, an embodiment of the invention can nonetheless be operative and useful.

### BRIEF DESCRIPTION OF THE FIGURES

The specification makes reference to the following appended figures, in which use of like reference numerals in different figures is intended to illustrate like or analogous components.

FIG. 1 provides a schematic illustration of a microscope system in accordance with various embodiments of the inventions.

FIG. 2 provides a schematic illustration of a sample illumination configuration in accordance with various embodiments of the inventions.

FIG. 3 provides a schematic illustration of a sample illumination configuration in accordance with various embodiments of the inventions.

FIG. 4 provides a schematic illustration of a hyperbranched tree of beamsplitters in accordance with various embodiments of the inventions.

FIG. 5 provides a schematic illustration of a hyperbranched tree of beamsplitters in accordance with various embodiments of the inventions.

### DETAILED DESCRIPTION

Microscope systems and methods described herein enable quick and efficient imaging of large areas of a sample, which can be advantageous for fluorescence microscopy, where detection signals can be of relatively low magnitudes and can be spread among a variety of detection wavelengths, typically requiring long signal acquisition for conventional systems. Additional complexity may be introduced to fluorescence microscopy when multiple excitation wavelengths are used, but the disclosed microscope systems overcome such limitations. In various embodiments, the microscope systems described herein achieve high throughput by employing light sources that generate multiple excitation wavelengths, while using a detection scheme that efficiently spatially separates fluorescence from the sample across multiple detection wavelength channels into spatially distinct pathways and images the fluorescence from the sample at each spatially distinct pathway using a separate photosensor. Further, in various embodiments the disclosed microscope systems are sensitive enough to provide useful spatial detection of components in the sample and in some configurations without operating under diffraction limited conditions. In various embodiments, microscope systems and methods described herein collect images corresponding to at least 1 cm² of a surface of a sample in less than 5 minutes.

In various embodiments, a microscope system comprises a sample holder; a light source positioned in optical communication with the sample holder and configured to direct illumination onto a sample in the sample holder; light distribution optics positioned in optical communication with the sample holder and configured to collect output light from the sample and spatially separate the output light collected from the sample into at least 8 detection channel wavelength bands; and at least 8 photosensors positioned in optical communication with the light distribution optics, each photosensor positioned to receive a corresponding spatially separated detection channel wavelength band from the sample. In various embodiments, the output light from the sample corresponds to fluorescence generated by the sample, such as corresponding to use of the microscope system as a fluorescence microscope. In various embodiments, the output light from the sample corresponds to light scattered or diffracted from the sample or transmitted by the sample, such as corresponding to use of the microscope system as a bright field microscope or dark field microscope, also referred to respectively as brightfield and darkfield microscopy. In various embodiments, at least 16 detection channel wavelengths are used. In various embodiments, at least 16 photosensors are used.

In various embodiments, a microscope system according to the disclosure herein is operated as an optical (e.g., magnifying) microscope, and, for example, the light source comprises a white light source and the different detection channel wavelength bands correspond to different regions of the visible spectrum (e.g., different colors or different specific wavelength ranges). Staining of the sample may be used to enhance contrast for different components, such as a cell types or different sub-cellular structures.

In various embodiments, a microscope system disclosed herein operates in a fluorescence microscopy application, and, for example, the light source comprises a plurality of different narrow-band light sources, such as lasers or light emitting diodes, used to excite fluorescent tags in the sample to generate fluorescent emission as output light from the sample. The excitation wavelengths from the plurality of different light sources may be directed onto the sample via the light distribution optics, with one or more optical paths within the light distribution optics used to direct light from the plurality of different light sources onto the sample and other optical paths within the light distribution optics used to spatially separate and detect different bands of fluorescent emission from the fluorescent tags.

The terms tags and labels may be used interchangeably herein to refer to an optically detectable light absorbing component, which may in various embodiments be detectable by way of fluorescent emission. Example tags or labels include, but are not limited to, fluorophores, dyes, stains, chromophores, or the like.

In various embodiments, multiple excitation wavelengths and/or bands of wavelengths, are used, such as, for example, to improve efficiency in the excitation and detection of a variety of different tags. For example, upon exposure to light from each excitation wavelength and/or wavelength band, different fluorescent tags may generate different fluorescent emission, which is imaged across a variety of different detection channel wavelength bands. In various embodiments, imaging a sample at the different detection channel wavelength bands provides a multispectral data set with each photosensor providing an image corresponding to the wavelength band directed to it by the optical distribution system. In various embodiments, the multispectral dataset is combined and rendered as a color digital image, showing the overall positions, colors, and intensities of different wavelengths of emission detected. Although such a color digital image can be useful for some analyses, it may not reflect the full amount of information available in the multispectral dataset, so other analysis of the multispectral dataset may be desirable.

In various embodiments, fluorescent tags emit fluorescence across multiple detection channel wavelengths, which may overlap with the fluorescence generated by other fluorescent tags, and such a situation may complicate the analysis of the multispectral dataset, since fluorescence from different fluorescent tags can be mistaken for one another. To better identify the positions and relative amounts of different fluorescent tags in the sample, a process of spectral unmixing can be used, which can transform the multispectral dataset into a spectrally unmixed dataset, representing the spatial distribution of the different fluorescent tags in the sample. In various embodiments, the spatial distribution corresponds to an abundance or relative abundance of the different fluorescent tags distributed across the sample. This information can be used, for example, to segment cells identified in the multispectral dataset and, for example, used to determine spatial information and expression profiles of individual cells.

### Example Microscope Systems and Related Methods

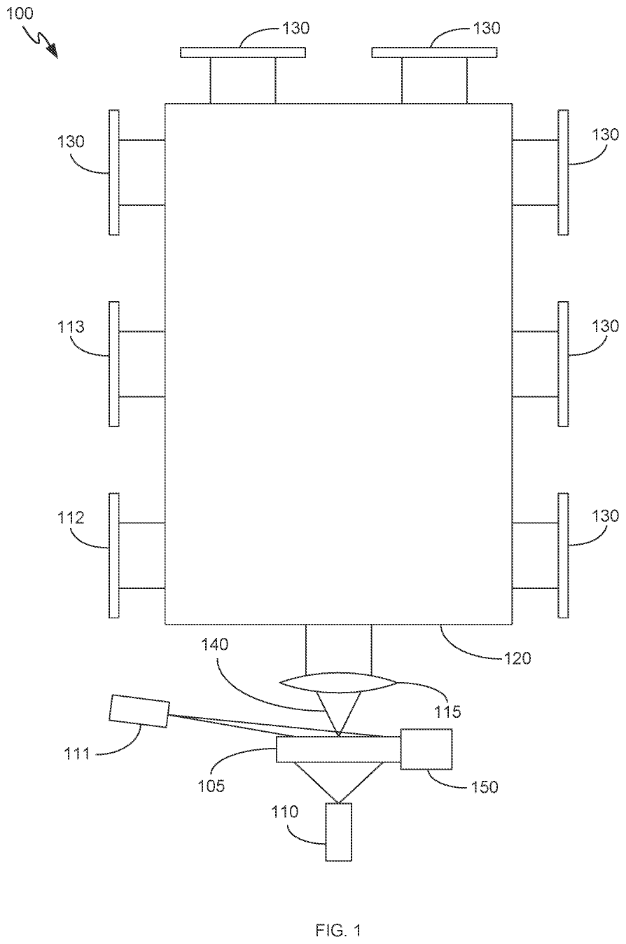

FIG. 1 provides a schematic illustration of an example microscope system 100. Microscope system 100 comprises a sample holder 105, one or more light sources 110, 111, 112, 113, objective lens 115, light distribution optics 120, and photosensors 130. In various embodiments, illumination is substantially coincident with the output light 140 from the sample. In various embodiments, sample holder 105 comprises a microscope slide holder, for example, such as for positioning a biological or other sample in position for imaging using microscope system 100. Sample holder 105 is shown coupled to a translation stage 150, which is used, for example, to adjust a relative position of the sample in at least two directions (e.g., X and Y directions) and in various embodiments in three directions (e.g., X, Y, and Z directions). Translation stage 150 is useful for scanning different regions of the sample or for adjusting focus, for example.

Although four light sources 110, 111, 112, 113 are shown, such a configuration is optional and one or more light sources may be used in various configurations. In various embodiments, one light source 110 is shown on the opposite side of sample holder 105 from objective lens 115 and light distribution optics 120, such as to provide for a transillumination configuration. Another light source 111 is shown on the same side of sample holder 105 as objective lens 115 and light distribution optics 120, such as to provide for an epi-illumination configuration. One or more additional light sources 112, 113 is shown arranged to share an optical path with a set of light distribution optics and provide for illumination of the sample substantially coincident with the output light path 145. Although only a single objective lens 115 is shown in FIG. 1, an objective used in microscope systems described herein may comprise a plurality of objective lenses.

As illustrated, the various positions and configurations of light sources 110, 111, 112, 113 are provided to illustrate flexibility in the illumination of the sample in sample holder 105. Light distribution optics 120 is useful to both direct fluorescence light emitted by the sample in the sample holder 105, to the various photosensors 130, but also to direct light emitted by one or more light sources 112 or 113 to the sample. The light sources 110, 111, 112, 113 emit the same or different wavelengths of light and in various embodiments one or more of the light sources 110, 111, 112, 113 are not present in the microscope system 100.

Details of light distribution optics 120 are not shown in FIG. 1 so as not to obscure other details, but light distribution optics may comprise a variety of optical components such as lenses, relay lenses, mirrors, beamsplitters, prisms, gratings, windows, waveguides, filters, including polarization filters, or the like, arranged to spatially separate output light 145 collected from the sample retained by the sample holder 105 into various detection channel wavelengths or wavelength bands and/or to direct light emitted by one or more light sources 112, 113 onto the sample. Light distribution optics direct each of the different detection channel wavelengths to different photosensors 130 and/or direct light from different light sources 112, 113 onto the sample.

As used herein, a “channel” may refer to a band of frequencies or wavelengths of light, which can be spatially separated from one another to allow for independent distribution, detection, or transmission, such that the term “channel” may also refer to an optical path or an optical path endpoint for light of a particular band or combination of bands. Channels may refer to collection or detection channels, corresponding to bands of frequencies or wavelengths of light from a sample (e.g., fluorescent light emitted by the sample) that are collected and directed to one or more optical detectors, such as photosensor, or optical paths that the bands of frequencies or wavelengths of light take from the sample to the optical detectors. Channels may refer to illumination channels, corresponding to band of frequencies or wavelengths of light directed onto or arranged to be directed onto a sample, or optical paths that the bands of frequencies or wavelengths of light take from a light source to the sample.

Different optical paths between objective lens 115 and the one or more light sources 112, 113 or various photosensors 130 in light distribution optics 120 may be referred to herein as different channels, which may be further referred to as light distribution channels. In various embodiments, light distribution optics 120 comprises or provides a plurality of different light distribution channels which are distributed between and among any desired configuration or number of different light sources and different photosensors. For example, if light distribution optics 120 provides 32 light distribution channels, these light distribution channels may be divided between 24 collection channels (light distribution channels for providing light from the sample to a photosensor) and 8 illumination channels (light distribution channels for providing light from a light source to the sample). Such a configuration of 24 collection channels and 8 illumination channels is merely one example. For example, in various embodiments, 24 collection channels are configured to provide 12 channels of fluorescence with 2× redundancy (e.g., 2 channels per wavelength band), such as to improve fidelity of compensation (aka spectral unmixing) algorithms. In other examples, different numbers of collection channels and illumination channels are used. In various embodiments, not all light distribution channels are used as a collection channel or an illumination channel.

Methods are also disclosed herein, such as methods for obtaining images of a sample or for operating a microscope system. In various aspects, methods comprise obtaining a multispectral data set using a microscope system, for example. Various embodiments of methods of this aspect comprise exposing a sample to illumination from a light source; collecting output light from the sample using light distribution optics positioned in optical communication with the sample; spatially separating the output light into at least 8 detection channel wavelength bands using the light distribution optics where each wavelength band is directed onto a different optical path; imaging the spatially separated output light wavelength bands onto its own photosensor, such that each photosensor is associated with a corresponding detection channel wavelength band; and generating one or more images of the sample using one or more of the photosensors. In various embodiments, methods described herein or various method steps described herein are performed by or using a microscope system. In various embodiments, various method steps are performed using one or more processors of a microscope system.

A variety of different light sources and configurations may be used with the microscope systems and methods described herein. For example, in various embodiments, a light source is configured to provide bright field illumination. In various embodiments, a light source is configured to provide dark field illumination. In various embodiments, a light source is configured for transillumination. In various embodiments, a light source is configured for epi-illumination. A light source and light distribution optics may be positioned on the same side of the sample holder or on different or opposite sides of the sample holder. In various embodiments, a light source is positioned to direct its illumination toward light distribution optics or a component thereof, such as for example through the sample holder and sample. In various embodiments, a light source is positioned to direct the illumination toward the sample holder or a surface of the sample at an oblique angle. In various embodiments, a light source is positioned to direct the illumination toward the sample holder or a surface of the sample along an optical path substantially coincident with the output light path. In various embodiments, a light source is positioned to direct its illumination toward the sample holder and sample along one or more light distribution channels provided by the light distribution optics.

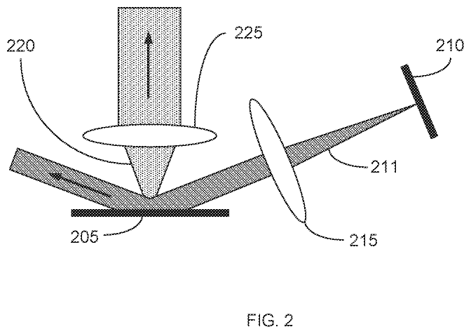

As an example, referring to FIG. 2, illumination according to an epi-illumination configuration is shown. In FIG. 2, an illumination source 210 emits light 211 towards a sample 205 at an oblique angle. One or more optical elements 215 are used to focus and direct light 211 onto the sample 205. Components within the sample 205 absorb various wavelengths of light 211 and generate fluorescence and light scattering. At least a portion of the fluorescence and/or scattered light 220 is collected by an objective lens 225 and is directed into a light distribution optics system (not shown in FIG. 2) for detection by one or more photosensors. Use of illumination according to an epi-illumination configuration of this nature may provide a benefit of limiting the light 211 from illumination source 210 from entering the objective lens 225 and being directed to the one or more photosensors. In this way, a signal-to-noise ratio for detection of the fluorescence 220 may be maintained at a relatively high level as compared to a configuration where light from an illumination source reaches the one or more photosensors, increasing noise levels.

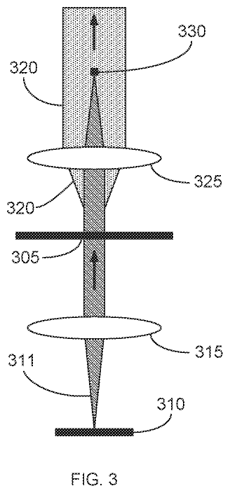

As an example, referring to FIG. 3, illumination according to a trans-illumination configuration is shown. In FIG. 3, an illumination source 310 emits light 311 towards a sample 305 at an orientation directly towards an objective lens 325. One or more optical elements 315 are used to focus and direct light 311 onto the sample 305. Components within the sample 305 absorb various wavelengths of light 311 and generate fluorescence. At least a portion of the fluorescence 320 is collected by the objective lens 325 and is directed into a light distribution optics system (not shown in FIG. 3) for detection by one or more photosensors. To limit light 311 from illumination source 310, an annular filter 330 is used to block and/or collect light 311. Annular filter 330 is depicted as positioned behind objective lens 325, which allows focusing light 311 to a small dimension such that annular filter 330 also takes on a similarly small dimension and limits the amount of fluorescence 320 blocked by annular filter 330. In this way, a signal-to-noise ratio for detection of the fluorescence 320 may be maintained at a relatively high level as compared to a configuration where light from an illumination source reaches the one or more photosensors, increasing noise levels.

Example light sources include, but are not limited to, unfiltered brightfield illumination sources, white light illumination sources, broadband illumination sources, or narrow-band illumination sources. In various embodiments, a light source comprising multiple LED elements is used and, for example, light from individual LEDs or mixed light from two or more LEDs may be used. Thus, in various embodiments employing LEDs, illumination by the LEDs is conducted electronically which provides greater speed of selection and use over traditional approaches that employ filter wheels to select illumination wavelength. In various embodiments, a broadband or white light illumination source is used and optionally coupled with a filter wheel. Such a configuration allows for selection of a discrete number of different wavelengths or bands for the illumination, for example. A light source may optionally comprise various optical components, such as lenses, mirrors, beamsplitters, prisms, gratings, windows, waveguides, or filters to shape, direct, or otherwise modify the illumination, as desired. In various embodiments, a light source comprises a multi-notch filter. In various embodiments, wavelengths of illumination passed by the multi-notch filter are filtered out or blocked by light distribution optics.

In various embodiments, a light source is configured to cycle between different illumination wavelengths, such as sequential illumination after one another, of a plurality of different excitation wavelengths. In various embodiments, a light source is configured to cycle between at least 4 different wavelengths. Example wavelengths used for the light source may be in the range of from 200 nm to 5000 nm.

In various embodiments, a light source is configured to provide multi-spectral illumination in discrete bands. In various embodiments, a light source directs a spectrum of wavelengths onto the sample. In various embodiments, a light source comprises a prism or grating to direct a spectrum of wavelengths onto the sample.

In various embodiments, a light source comprises one or a plurality of laser sources. In various embodiments, a light source comprises one or a plurality of light emitting diodes (LEDs), superluminescent light emitting diodes, or both LEDs and superluminescent light emitting diodes. In various embodiments, when a plurality of lasers or a plurality of light emitting diodes is used as the light source, they are configured to sequentially illuminate the sample, such as, for example, by alternating the illumination wavelength between different wavelengths or wavelength ranges, or they are configured to illuminate the sample simultaneously. In various embodiments, the lasers output light of at least two harmonics simultaneously. In various embodiments, a light emitting diode used as the light source exhibits an emission bandwidth of 10-30 nm in range. In various embodiments, multiple light emitting diodes are used to span a broad wavelength range. In various embodiments, central wavelengths for a light source may range from about 200 nm to about 5 μm.

In various embodiments, the photosensors are used to image the output light from the sample at each of the different detection channel wavelength bands. In various embodiments, only a sub-region of the sample is imaged at any one time and the sample is then translated in two dimensions (e.g., in the X-Y) plane to image another sub-region. For example, the sample holder may be coupled to a translation stage to effect a translation of the sample. In various embodiments, the light distribution optics may be coupled to a translation stage to effect a relative translation between the sample and the light distribution optics. Automatic translation in the X-Y plane can allow for imaging of multiple regions of the sample, which in various embodiments can be stitched together using digital imaging stitching techniques. In various embodiments, the field of view of the sample imaged on the photosensor is related to the numerical aperture and/or the magnification factor. In various embodiments, the field of view has lateral dimensions of at least 0.25 mm.

In various embodiments, a translation stage is adjustable in three dimensions to allow the distance (Z position) between the sample and the light distribution optics to be adjusted, for example, to adjust focus. In various embodiments, the Z position is automatically adjusted (e.g., to autofocus, to follow a previously measured topology of the specimen, etc.), using software control.

In various embodiments, the disclosed microscope systems and methods include or employ an autofocusing technique. Examples of autofocusing techniques include, but are not limited to, where an autofocus system is coupled to the sample holder, the light distribution optics, one or more photosensors, or one or more translation stages coupled to any of these. Example autofocus systems include static autofocus systems, live autofocus systems, or closed loop autofocus systems. For example, autofocus systems may adjust a Z position of the sample or the sample holder, or a relative distance between the sample holder and one or more elements of the light distribution optics or an objective lens. In various embodiments, the autofocus system is configured or used to generate or obtain a surface profile prior to acquiring images of the output light from the sample. Useful autofocus systems and techniques include, but are not limited to, those described in PCT International Application Publication No. WO 2020/055810, hereby incorporated by reference.

In various embodiments, a translation stage coupled to the sample holder or light distribution optics is used to adjust a position (or relative position) of the sample while images of output light from the sample are obtained. For example, the translation stage can be configured to (a) stop motion (or relative motion) during a dwell time of image acquisition. (b) generate motion (or relative motion) at a constant velocity, such as when cycling the light source between different illumination wavelengths, and/or (c) generate motion (or relative motion) while imaging output light from the sample at multiple photosensors simultaneously. In various embodiments, one or more de-scanning mirrors may be included in the light distribution optics to, for example, maintain an image on a photosensor while the position (or relative position) of the sample is adjusted. Example de-scanning mirrors include, but are not limited to, galvanometric mirrors and MEMS mirrors.

Various photosensors can be used with the microscope systems and methods described herein. Suitable photosensors include but are not limited to CMOS image sensors, active-pixel image sensors, and CCD image. In various embodiments, the photosensors are CMOS image sensors and/or active-pixel image sensors. In various embodiments, CMOS image sensors exhibiting a sub-electron readout level are used. In various embodiments, the photosensors can all have substantially the same size, detection area, number of pixels, pixel size, pixel pitch, and/or pixel density, or these aspects may vary among different photosensors. In various embodiments, at least one photosensor has a different size, detection area, number of pixels, pixel size, pixel pitch, and/or pixel density from another photosensor, which, for example, can be useful for allowing one or more channels to provide images with a higher pixel count.

Different individual photosensors may be used for each of the different detection channel wavelength bands. In various embodiments, different photosensors used to image different detection channel wavelength bands correspond to sub-arrays (for example different physical areas on a sensor surface) of a single or common photosensor. In various embodiments, the photosensors are used to image output light from the sample at two or more, or all, of the respective detection channel wavelength bands at substantially the same time as one another (e.g., substantially simultaneously). In various embodiments, the photosensors are used to image output light from the sample at two or more, or all, of the respective detection channel wavelength bands while cycling through illumination channels sequentially.

### Example Light Distribution Optics Configurations

Spatial separation of the output light from the sample into different detection channel wavelength bands and/or direction of light from one or more light sources onto the sample may be achieved using any suitable configuration of the light distribution optics, which may comprise, for example, one or more lenses, mirrors, beamsplitters, prisms, gratings, windows, or filters. As used herein, the term “beamsplitter” refers to any optical element that receives incident light beam comprising a range of wavelengths and spatially separates a beam with one range of wavelengths, also referred to as a wavelength band, from a beam with another range of wavelengths. Accordingly, the term beamsplitter when used in this context may encompass prism, gratings, dichroic mirrors, dichroic cubes, plate beamsplitters, cube beamsplitters, plate beamsplitters, and pellicle beamsplitters. In various embodiments, dichroic cubes include X-cube technology. Other suitable multi-color prism technology that separates more than two colors in one assembly is trichroic prism. In various embodiments, a series of beamsplitters separates the output light from the sample into different channel wavelength bands. It is to be understood that two wavelength bands differ if the center wavelength of the bands differ. In various embodiments, two wavelength bands are further differentiated by the width of one wavelength band being different from that of a second wavelength band. Accordingly, it is to be understood that wavelength bands may differ yet still have some overlap in the wavelengths they transmit.

In various aspects, the light distribution optics comprise a hyperbranched tree of beamsplitters. In various embodiments, a hyperbranched tree of beamsplitters comprises an arrangement of beamsplitters such that two or more beamsplitters are present along each optical path from a sample to four or more optical path endpoints or from each of the four or more optical path endpoints to the sample. Optical path endpoints may include photosensors, light sources, or alternate endpoints besides a photosensor or light source, for example. In various embodiments, a hyperbranched tree of beamsplitters comprises an arrangement of beamsplitters such that three or more beamsplitters are present along each optical path from a sample to eight or more optical path endpoints or from each of the eight or more optical path endpoints to the sample. In various embodiments, a hyperbranched tree of beamsplitters comprises an arrangement of beamsplitters such that four or more beamsplitters are present along each optical path from a sample to sixteen or more optical path endpoints or from each of the sixteen or more optical path endpoints to the sample.

In various embodiments, two or more beamsplitters are fused together to form one beamsplitter with multiple channels. For example, a single cube beamsplitter may split the light into two channels. In various embodiments, three cube beam splitters are fused together to form an L-shape. These three cubes may then split the light into 4-channels. The first cube splits the light into two branches and then each of the branches is split into two by the next cube. Thus, a fused L-shape beamsplitter may be used as an optical element that collects the light and splits it into 4 outputs based on the wavelength bands. In various embodiments, after this splitting, one or more of the outputs are sent to another L-shape beam splitter to split the bands four times there. In various embodiments, a branched structure is formed of a fused optical element made of multiple cubes to, for example, form a branched or hyperbranched tree. In various embodiments, the fused elements are included for a number of levels of branching, with additional branching levels provided using non-fused elements, e.g., planar beamsplitters.

In various embodiments, a branched structure is arranged to utilize branching in three dimensions. Although it is common in contemporary optics to arrange an optical structure as a two-dimensional assembly, arrangement of elements of a light distribution optics, such as a branched or hyperbranched tree of beamsplitters, in three dimensions may be useful for minimizing or reducing the number of relay lenses. In various embodiments, mounting optical elements to such a three-dimensional assembly employs a scaffold, which may, for example, be 3D printed. Example materials for a scaffold include, but are not limited to, one or more of aluminum, copper, or invar. In various embodiments, a scaffold includes 3D printed metal structures with fluid channels for liquid cooling or evaporative cooling or heat-pipe cooling to facilitate additional thermal stability.

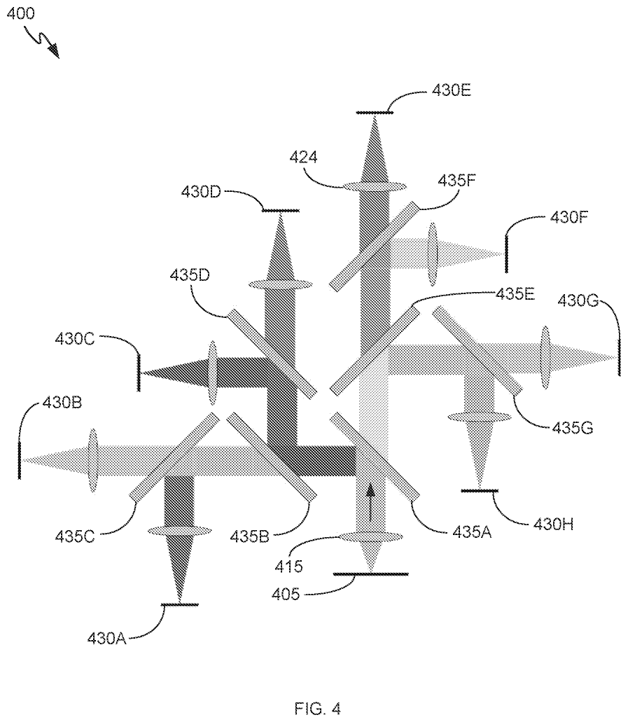

Referring next to FIG. 4, one example of a light distribution system 400 according to various aspects and embodiments of the inventions is depicted. A sample 405 and objective lens 415 are shown below the light distribution system 400, with various optical path endpoints 430A, 430B, 430C, 430D, 430E, 430F, 430G, and 430H arranged around the periphery of light distribution system 400. In various embodiments, each endpoint 430A-430H comprises a photosensor or a light source, as described herein. Optical paths between each endpoint 430A-430H and the sample 405 and/or objective lens 415 includes a plurality of beamsplitters. In various embodiments, the number of beamsplitters in each optical path is the same. In other embodiments, the number of beamsplitters differ between two or more of the optical paths.

Although each beamsplitter 435A-435G is illustrated as producing two branches (e.g., a binary beamsplitter), that is directing light of one wavelength band in a first spatial direction and directing light of a different wavelength band in a second direction (for example, beamsplitter 435A illustrating directing light of a first wavelength band in a first direction toward beamsplitter 435B, and light of a second wavelength band in second direction toward beamsplitter 435E), it is to be understood that in various embodiments a beamsplitter may produce light split into three or more wavelength bands along three or more corresponding directions. Accordingly, in various embodiments, each beamsplitter may be conceptualized as a node that splits light into at least two different branches.

For example and in various of the examples, the number of beamsplitters in an optical path may be referred to as the level of branching. As illustrated in FIG. 4, light distribution system 400 includes 7 beamsplitters 435A, 435B, 435C, 435D, 435E, 435F, and 435G. Beamsplitter 435A provides a first level of branching, beamsplitters 435B and 435E each provide a second level of branching, and beamsplitters 435C, 435D, 435F, and 435G each provide a third level of branching.

In various embodiments, the total number of optical paths N using a series (also referred to as a tree) of beamsplitters with a splitting factor A corresponds to A to the power L (A^{L}), where L is the branching level of beamsplitters, with the minimum number of beamsplitters corresponding to

$${\sum }_{B = 1}^{L} {A}^{( B - 1 )}$$

For a binary beamsplitter, having a splitting factor of 2, the number of paths is 2 to the power L (2^{L}), and the minimum number of beamsplitters according to the above sum simplifies to 2^{L}-1.

For example, in various embodiments, a 2 level hyperbranched tree of binary beamsplitters (e.g., two-way beamsplitters or beamsplitters with a splitting factor of 2) has four optical paths (2²), and includes three (2²-1) binary beamsplitters, where the first binary beamsplitter splits a common path into two sub-paths, the two sub-paths are each split by another binary beamsplitter (two total, one for each sub-path) into the four paths. As another example, in various embodiments, a 3 level hyperbranched tree of binary beamsplitters has eight paths (2³), and includes seven (2³-1) binary beamsplitters, where the first binary beamsplitter splits a common path into two sub-paths, the two sub-paths are each split by another binary beamsplitter (two total, one for each sub-path) into four sub-sub-paths, and the four sub-sub-paths are each split by another binary beamsplitter (four total, one for each sub-sub-path) into the eight paths. As additional examples, in various embodiments a 4 level hyperbranched tree of binary beamsplitters has sixteen paths (2⁴), and includes fifteen (2⁴-1) binary beamsplitters and a 5 level hyperbranched tree of binary beamsplitters has thirty-two paths (2⁵), and includes thirty-one (2⁵-1) binary beamsplitters.

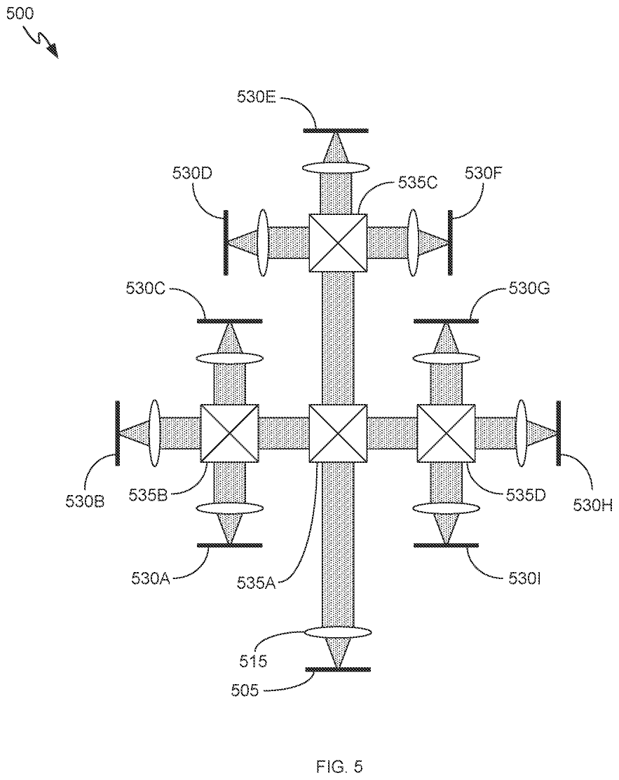

Referring to FIG. 5, another example of a light distribution system 500 according to various aspects and embodiments of the inventions is depicted. A sample 505 and objective lens 515 are shown below the light distribution system 500, with various optical path endpoints 530A, 530B, 530C, 530D, 530E, 530F, 530G, and 530I arranged around the periphery of light distribution system 500. In various embodiments, each endpoint 530A-530I comprises a photosensor or a light source, as described herein. Optical paths between each endpoint 530A-530I and the sample 505 and/or objective lens 515 includes a plurality of three-way beamsplitters (e.g., beamsplitters with a splitting factor of 3). In various embodiments, the number of beamsplitters in each optical path is the same. In other embodiments, the number of beamsplitters may be differ between two or more of the optical paths.

In FIG. 5, each beamsplitter 535A-53C is illustrated as producing three branches (e.g., a three-way beamsplitter), that is directing light of a first wavelength band in a first direction, directing light of a second wavelength band in a second direction, and directing light of a third wavelength band in a third direction (for example, three-way beamsplitter 535A illustrating directing light of a first wavelength band in a first direction toward three-way beamsplitter 535B, light of a second wavelength band in second direction toward three-way beamsplitter 535B, and light of a third wavelength band in a third direction towards three-way beamsplitter 535D). In various embodiments, a three-way beamsplitter is implemented as an X-cube, but other implementations are also possible, such as pairs of fused cube beamsplitters. As illustrated in FIG. 5, light distribution system 500 includes 4 three-way beamsplitters 535A, 535B, 535C, and 535D. Three-way beamsplitter 535A provides a first level of branching, and three-way beamsplitters 535B, 535C, and 535D each provide a second level of branching. In various embodiments, the total number of optical paths N may correspond to 3 to the power L (3^{L}), where L is the branching level of three-way beamsplitters, with the minimum number of three-way beamsplitters determined according to

$${\sum }_{B = 1}^{L} {3}^{( B - 1 )}$$

For example, in various embodiments, a 2 level hyperbranched tree of three-way beamsplitters has nine paths (3²), and includes four (2²-1) three-way beamsplitters, where the first three-way beamsplitter splits a common path into three sub-paths, the three sub-paths are each split by another three-way beamsplitter (three total, one for each sub-path) into the nine paths. As another example, in various embodiments, a 3 level hyperbranched tree of three-way beamsplitters has twenty seven paths (3³), and includes thirteen three-way beamsplitters, where the first three-way beamsplitter splits a common path into three sub-paths, these three sub-paths are each split by another three-way beamsplitter (three total, one for each sub-path) into nine sub-paths, these nine sub-paths are each split by another three-way beamsplitter (nine total, one for each sub-path) into twenty seven sub-paths.

In various embodiments, light distribution optics comprising at least 2 levels of branching further comprise additional beamsplitters before and/or after the at least 2 levels of branching. For example, a first beamsplitter may direct a first sub-path into a 2 level hyperbranched tree of beamsplitters and direct a second sub-path to a photosensor array (e.g., without any additional beamsplitters between the second sub-path and the photosensor). Alternatively or in addition, a hyperbranched tree of beamsplitters may direct at least one sub-path into additional beamsplitters of the light distribution optics. For example, at least one sub-sub path output by a 2 level hyperbranched tree of beamsplitters may be further split by an additional beamsplitter of the light distribution optics (and in various embodiments while at least one other sub-sub path output by the 2 level hyperbranched tree of beamsplitters may not be split by any additional beamsplitters).

In various embodiments, a hyperbranched tree of beamsplitters spatially separates the output light collected from the sample into the at least 8 detection channel wavelength bands. In various embodiments, the light distribution optics splits light collected from the sample such that it is directed towards at least 15 different optical path endpoints, where each different optical path may correspond to a different band of wavelengths to be detected by a different photosensor at the optical path endpoint.

In various embodiments, a hyperbranched tree of beamsplitters is useful for at least one of reducing loss of light and reducing distortion of light when a large number of detection channels are used (e.g., 10 or more), as this can limit the number of beamsplitters in the path for each detection channel, particularly when compared to a linear arrangement of beamsplitters. Any suitable number of branching levels may be used in the hyperbranched tree of beamsplitters, such as from 2 levels to 8 levels, at least 2 levels, at least 3 levels, at least 4 levels, or at least 5 levels. In various embodiments, a hyperbranched tree of beamsplitters branches in two dimensions, such as where the beamsplitters may be arranged in two dimensions to define paths that all lie in the same plane. In various embodiments, a hyperbranched tree of beamsplitters branches in three dimensions, such as where the beamsplitters may be arranged in three dimensions to define paths in any orientation, including out-of-plane orientations. Branching in three dimensions may be useful for some cases to allow for a more compact arrangement of the beamsplitters, particularly when the branching level is large (e.g., at least 4 levels). In various embodiments, hyperbranched tree of beamsplitters comprises a set of beamsplitters that branches in two dimensions and a set that branches in three dimensions.

In various embodiments, an individual photosensor may be positioned at the end of each optical path or branch of a hyperbranched tree of beamsplitters. In various embodiments, the lights distributions optics are used for sample illumination as well as light collection. For example, in various embodiments, some optical paths of a hyperbranched tree of beamsplitters are used to provide optical communication between a light source and the sample, such as where one or more light sources are positioned at the end of one or more paths or branches of a hyperbranched tree of beamsplitters. In various embodiments, a light source may comprise one or more light emitting diodes arranged at an optical path endpoint to direct illumination through the hyperbranched tree of beamsplitters and towards a sample. In various embodiments, different light emitting diodes may be arranged at different optical path endpoints to direct illumination through the hyperbranched tree of beamsplitters and towards a sample, such that the sample can be illuminated by each of the different light emitting diodes simultaneously or independently. In various embodiments, some paths of the hyperbranched tree of beamsplitters do not have a photosensor or a light source at the optical path endpoint.

In various embodiments, one or more of the beamsplitters comprise a dichroic mirror, such as a dichroic mirror that transitions from 10% transmission to 90% transmission in less than 40 nm, in less than 20 nm, in less than 10 nm, in less than 5 nm, or in less than 3 nm. In various embodiments, a dichroic mirror transitions from less than 3% transmission to 90% transmission in less than 40 nm, in less than 20 nm, in less than 10 nm, in less than 5 nm, or in less than 3 nm. In various embodiments, a dichroic mirror exhibits a cutoff wavelength of 900 nm or higher, or 1200 nm or higher. In various embodiments, one or more beamsplitters comprise a metal coated mirror. In various embodiments, the beamsplitters direct at least 80% of the output light from the sample to one or more photosensors. In various embodiments, one or more beamsplitters comprise one or more prisms. In various embodiments, one or more beamsplitters split incident light into three or more wavelength bands.

Wavefront distortion can degrade image quality by reducing contrast or compromising resolution. Dichroic mirrors are generally composed of multi-layered, thin-film coatings on plane, parallel glass substrates. There may be variability in substrate flatness, and, additionally, the substrate may slightly bend after coating. For transmitted light, such bending has little effect on transmitted wavefront error (TWE) other than a slight displacement of the beam axis. However, for reflected light, especially light incident at non-perpendicular angles, deviations from flatness may induce effects on reflected wavefront error (RWE), such as, but not limited to, (1) the focal plane may shift position, and/or (2) the beam may acquire optical aberrations (e.g., astigmatism). As such, optical systems in which optical paths include multiple reflection points may accumulate large amounts of wavefront distortion or RWE.

RWE may impose limits on the usability of an optical system. Standard fluorescence (e.g., epi-fluorescence) microscopy may tolerate an RWE of 6λ or greater, for example, while other applications such as super-resolution TIRF may require an RWE of less than 0.2λ, for example. Various embodiments of the present inventions have application in fluorescence (e.g., epi-fluorescence) or brightfield microscopy. However, various embodiments of a hyperbranched tree of beamsplitters described herein reflect some wavelengths of light two or more times, and thus limiting or reducing RWE may be desirable. In various embodiments, the application of single cell imaging may be tolerant to a certain level of propagated RWE (e.g., a propagated RWE of up to 6λ, up to 3λ, or up to 1λ after multiple reflections in the hyperbranched tree of beamsplitters).

In various embodiments, cumulative or propagated RWE is reduced by employing individual beamsplitters with low RWE. In various embodiments, individual beamsplitters (e.g., dichroic mirrors) of a hyperbranched tree of beamsplitters have an RWE of 3λ or less, 2λ or less, 1λ or less, 0.5λ or less, 0.2λ or less, or 0.1λ or less. Such RWE may be achieved, for example, by using a substrate thickness of more than 1 mm, more than 2 mm, or more than 3 mm, for the individual beamsplitters. Increasing a substrate thickness can be useful for achieving lower RWE since the flatness of the beamsplitter can be better controlled with thicker substrates. In various embodiments, pellicle based dichroic mirrors or cube-based beam splitters can be used, for example, to facilitate reducing the RWE.

Other optical components, in addition to a hyperbranched tree of beamsplitters, can be included in the light distribution optics, such as lenses or filters. In various embodiments, one or more focusing lenses are included in the light distribution optics. For example, in various embodiments, individual focusing lenses (e.g., tube lenses) are positioned before each individual photosensor. In various embodiments, relay lenses are utilized between certain levels of branching. Relay lenses allow for reducing the density of the optical components by moving elements corresponding to upper branches further away from the sample and the microscope objective, for example.

In various embodiments, it is desirable to limit the illumination from the light source from reaching the photosensors. For example, in a fluorescence microscope configuration, the fluorescence intensity may be much lower than the excitation intensity of the illumination provided by the light source, and so limiting or blocking illumination from the light source can be useful for improving a signal to noise ratio. In various embodiments, one or more bandpass filters are included in the light distribution optics, such as for example positioned in front of the photosensors to, e.g., remove undesired tails of emission spectrum from LED light sources. In various embodiments, individual filters are positioned in front of each individual photosensor (e.g., in an optical path between a photosensor and the last beamsplitter directing light towards the respective photosensor). With reference to FIG. 4, such filters may be positioned, for example, between optical path endpoint 430A and beamsplitter 435C, between optical path endpoint 430B and beamsplitter 435C, between optical path endpoint 430C and beamsplitter 435D, between optical path endpoint 430D and beamsplitter 435D, between optical path endpoint 430E and beamsplitter 435F, between optical path endpoint 430F and beamsplitter 435F, between optical path endpoint 430G and beamsplitter 435G, and/or between optical path endpoint 430H and beamsplitter 435G. In various embodiments, one of the surfaces of the lens(es) between the beamsplitter(s) and the corresponding photosensor(s) (e.g., lens 424) can have the coating that filters the necessary band before the light reaches the corresponding photosensor(s). Thus, for example, reducing the number of optical components used in the assembly.

In various embodiments, a spatial filter can be used to limit or block the illumination from a light source from reaching a photosensor, such as, for example, a spatial filter that is matched to a geometry of a light source to block the illumination from the light source while still allowing output light from the sample to reach one or more photosensors. For example, with reference to FIG. 3, in various embodiments annular filter 330 corresponds to a spatial filter that is positioned to block light 311 from light source 310, while allowing fluorescence (and scattered light) 320 from sample 305 to reach a photosensor.

The disclosed microscope systems and methods, in various embodiments, include or employ an objective lens positioned between the sample holder and the light distribution optics or as part of the light distribution optics. In various embodiments, the objective lens comprises a plurality of objective lenses. In various embodiments, the objective lens is switchable and selectable from a number of different objective lenses, such as, for example, attached to a revolving nosepiece or turret. Useful objective lenses include, but are not limited to, those having a numerical aperture of from 0.1 to 1, 0.5 or greater, 0.55 or greater, 0.6 or greater, 0.65 or greater, 0.7 or greater, 0.75 or greater, 0.8 or greater, 0.85 or greater, 0.9 or greater, 0.95 or greater, or 1 or greater. In various embodiments, the numerical aperture of the objective lens is from 1 to 1.4. In various embodiments, an oil immersion lens is used as an objective lens. Useful objective lenses include, but are not limited to, those having a magnification factor of from 20× to 100×, about 20×, about 25×, about 30×, about 35×, about 40×, about 45×, about 50×, about 55×, about 60×, about 65×, about 70×, about 75×, about 80×, about 85×, about 90×, about 95× or about 100×.

### Operation Under Diffraction Limited or Non-Diffraction Limited Conditions

For operation of a microscope, it is sometimes desirable to obtain the maximum magnification level possible. However, there is an ultimate limit to the optical resolving power of a traditional microscope imposed by the diffraction properties of light—referred to as the diffraction limit. The limit generally refers to the smallest distance that can be resolved by an optical system. A microscope operating at or beyond the diffraction limit may be referred to herein as being diffraction limited. In practice, this may occur when the quality of optics is adequate and the images of the sample obtained by the photosensor have a pixel scale about equal to or smaller than the diffraction limit or about equal to or smaller than ½ of the diffraction limit. As used herein, the term pixel scale refers to the physical distance represented by a single pixel in an image.

The diffraction limit may be governed by at least the numerical aperture of the objective lens and the detection wavelength. For example, the diffraction limit for a particular wavelength of light and optical system may be equal to the wavelength of light divided by twice the numerical aperture of the optical system. For visible light having wavelengths of from 400 nm to 700 nm and a numerical aperture of from 0.5 to 1.0, the diffraction limit can range from about 0.2 μm to about 0.7 μm, which is sufficient for distinguishing most biological cells and some sub-cellular structures.

In various embodiments, at least one image obtained by the microscope systems or according to methods described herein has a pixel scale larger than a diffraction limit defined by at least the numerical aperture of an objective lens and a detection channel wavelength associated with the image. In various embodiments, the pixel scale for one or more photosensors is at least or about 1.2 times the diffraction limit, at least or about 1.5 times the diffraction limit, at least or about 1.8 times the diffraction limit, and/or at least or about 2 times the diffraction limit. In various embodiments, one or more of the photosensor are configured in a diffraction limited arrangement. In various embodiments, at least one image obtained by a microscope system or method according to those disclosed herein exhibits a pixel scale of at least 0.25 μm, for, for example, a detection channel wavelength of 600 nm or less.

When a microscope system is diffraction limited, increasing the pixel count of a photosensor may not allow for improvements in resolving power, since the light coming from a single point in the sample will be spread across different pixels on the photosensor. Thus, in various embodiments, it may be advantageous to operate under conditions that are not diffraction limited, such that light from a small range of positions, which may correspond to the pixel scale, in the sample is detected by about a single pixel on the photosensor. In various embodiments, by operating under conditions that are not diffraction limited, a wider field of view (e.g., corresponding to the total lateral dimensions of the sample represented in the light detected by the photosensor) can be obtained as compared to diffraction limited operation. In various embodiments, a larger pixel scale means that pixels of larger dimensions can be used, which can facilitate improving signal to noise since larger pixels can collect more light. In various embodiments, a larger pixel scale means that pixels with a larger pitch can be used. Another benefit of concentrating light from a point source into a few pixels is that it can improve the signal to noise ratio for the readout. In various embodiments, the total signal for the one pixel readout and the multipixel readout configurations can be identical or near identical. At the same the noise of one pixel is lower than the summed noise of many pixels.

In various embodiments, pixel pitch on at least one photosensor is greater than the diffraction limit times a magnification factor defined by at least the objective and the imaging optics. In various embodiments, pixel pitch on at least one photosensor is less than the diffraction limit times a magnification factor defined by at least the objective. For example, use of a photosensor with such a pixel pitch can facilitate improved cell segmentation and/or single molecule detection as described further herein.

In various embodiments, a non-chromatic beamsplitter is positioned between the sample holder and the light distribution optics or as part of the light distribution optics, and where the non-chromatic beamsplitter directs less than 50%, less than 20%, and/or less than 10% of the light from the sample to a photosensor that provides a high-resolution image of the sample.

In various embodiments, some of the photosensors have high density pixels while other photosensors will have low density of pixels. The high pixel density photosensors can, for example, provide the ability of accurate microscopic reproduction of fine image features while the low pixel density photosensors can, for example, enable high-speed, low-cost collection of integrated information on many optical channels.

The resolving power of a microscope can also generally be represented as a point spread function, corresponding to the response of the system to a point source in the sample, defined by at least the numerical aperture and the wavelength of light. In various embodiments, when a point spread function is mapped to or sampled by four or more pixels, or five or more pixels, of an imaging sensor, the system may be considered diffraction limited and with sampling frequency below Nyquist and Kell limits. Stated another way, for operation in a configuration that is not diffraction limited, less than 5 pixels of the image sensor will map or sample the point spread function.

In various embodiments, a microscope system may have less than 5 pixels of a plurality of the photosensors allocated to map or sample a point spread function defined by at least the numerical aperture of an objective lens and a spatially separated detection channel wavelength. In various embodiments, a plurality of the photosensors may be configured to detect a point source in the sample characterized by a dimension less than the diffraction limit onto less than 5 pixels of each the plurality of the photosensors.

### Additional Evaluation of a Sample or Sub-Regions of a Sample

In various embodiments, methods for obtaining images of a sample or for operating a microscope system include determining a region of interest of the sample. Regions of interest can be identified by evaluating a fluorescence image obtained by a microscope system to identify particular structures for which further investigation may be warranted. For example, a region of interest may comprise or correspond to a portion of a sample that includes a particular cell type, a particular sub-cellular structure, a particular tissue morphology, a particular region exhibiting a target or greater concentration of one or more fluorescent tags, or the like. In some cases, the region of interest may be tagged or identified for further processing or interrogation. In various embodiments, the further processing or interrogation may comprise staining, such as with one or more histochemical stains, with one or more mass-tagged affinity reagents, or the like.

In various embodiments, further processing or interrogation of a region of interest comprises mass spectrometry, such as imaging mass spectrometry. In various embodiments, further processing or interrogation of a region of interest comprises mass cytometry, such as imaging mass cytometry. For example, the further processing may include a process of scanning a laser on the region of interest to laser ablate material in the region of interest for introduction into a mass spectrometer. In various embodiments, microscope systems described herein further comprise or are coupled to a laser source for performing laser ablation on a region of interest. In various embodiments, microscope systems described herein further comprise or are coupled to a mass spectrometer or mass cytometer.

In various embodiments, the process of laser ablation frees material in the region of interest from the surface of the sample, where it can be drawn into an inlet in a mass spectrometer or mass cytometer for further evaluation, such as to identify tags (e.g., heavy metal ion tags) to definitively determine a composition or cell types of individual cells in the region of interest. In some examples, different antibodies are labeled with different heavy metal ion tags and so determination of the presence of a particular ion tag can indicate the presence of a particular antibody in the ablated region of interest and/or indicate exclusion of other antibodies in the ablated region of interest.

The microscope systems and methods for obtaining images of a sample or for operating a microscope system described herein can enhance a process of evaluating a sample or region of interest of a sample by mass spectrometry or mass cytometry by allowing for rapid collection of images of the sample to quickly identify a region of interest of a sample for further evaluation.

In various embodiments, methods for obtaining images of a sample or for operating a microscope system include sample preparation steps, such as array tomography. The microscope systems and methods for obtaining images of a sample or for operating a microscope system are useful for enhancing a rate at which images of the sample can be obtained, as samples can be illuminated using multiple illumination channels rapidly in sequence, with fluorescent emission generated in response to each illumination channel evaluated at multiple detection channels simultaneously. These aspects can reduce image acquisition time, allowing for more images to be obtained in a smaller amount of time, which can provide a direct benefit to array tomography, where many sections of a sample are imaged sequentially to provide a 3D image of components of the sample.

In various versions of array tomography, a tissue sample, such as a resin-embedded tissue sample or FFPE tissue sample, is serially sectioned, and optionally stained. For example, the sample may be fixed and embedded with a methyl methacrylate resin, such as butyl-methyl methacrylate (BMMA), or subjected to formalin fixation and paraffin embedding (FFPE). A fixed and embedded sample may be sectioned into an array of thin sections, e.g., each having a thickness that is less than 2 μm, less than 1 μm, less than 0.5 μm, less than 0.2 μm, less than 0.1 μm, or less than 0.05 μm. As such, a fixed and embedded sample may be sectioned into an array of more than 10, more than 20, more than 50, or more than 100 serial sections.

In various embodiments, each section is imaged using a microscope system described herein and/or according to methods for obtaining images of a sample or for operating a microscope system described herein. In various embodiments, the images are re-assembled into a 3D image. In various embodiments, microscope systems and methods described herein enable imaging large numbers of samples or sample sections in a relatively short amount of time. For example, by imaging 400 samples or sections in one day, a 3D image of a sample at single cell resolution of a volume of 5×5×5 mm can be obtained in about 12 hours.

In various embodiments, a sample volume of tissue is subjected to array tomography and imaging, as described above, with the resultant 3D image evaluated to identify a particular volume of interest, and then the volume of interest evaluated further, such as using mass spectrometry or mass cytometry.

In various embodiments the microscope can be utilized to detect single copy entities on a specimen. Such entities, for example, could be single molecules or tags or amplified derivatives of single molecules or tags. Various methods of signal amplification are known in the art. In some of these, multiple fluorophores are attached to a single tag. In other methods several fluorophores are catalytically precipitated in the vicinity of the single copy tag. Single copy entities typically need to be present at low concentration to avoid signal overlap and interpretation errors from typical processing algorithms. In the case of a high-density antigen, for example, the low density of single copy tags can be accomplished by diluting the antibody concentration that targets the antigen of interest.

In various embodiments, single copy entities can be further barcoded utilizing several different color fluorophores. This can allow for detection of many different types of targets by associating each target with a different barcode. In various embodiments, the barcoding scheme can have redundancy to some information errors generated due to noise in the signals or overlap of nearby entities in the sample. As various aspects and embodiments of the systems and methods described herein can read many color bands simultaneously, by executing spectral unmixing, several barcoded targets can be followed. Moreover, in various embodiments, the position in space of each single copy light source can be determined with precision that is better than the range of diffraction limit. This can result in a virtual super-resolution mapping of the singly copy entities. Thus, for example, barcoded entities can reside just within 100 nm from each other and still be correctly interpreted in their corresponding barcodes and positions using various aspects and embodiments described herein. For example, without being bound by any theory, one can view the method of interpretation of data in the single copy barcoded mode as spectral and positional unmixing of single copy entities. If more barcode reporters are needed for a given experiment various embodiments of the systems and methods described herein can rapidly read the sample and then, for example, the same sample can be further stained with another set of reagents for another round of readout. Images obtained in two imaging cycles can be co-aligned using various techniques including imaging of fiducial marks placed on the sample. Such a mode of operation is referred to as cyclical fluorescent microscopy.

In addition, the upper limit of dynamic range of single copy detection system is typically quite low due to the need to mitigate potential for signal overlap from nearby entities. This limitation can be improved by serial sectioning with thinner sections. For instance, if one utilizes BMMA sections of 250 nm in thickness, then a common FFPE tissue section of 5 μm thickness will be subdivided into 20 sections. Reading these BMMA sections and reconstructing the volumetric image offers enhancement of dynamic range by 20× for a given volume which is critical for some applications. However, to read this volume with 250 nm sections of BMMA one would require 20 times more readout area throughput; various aspects and embodiments described herein can provide this, offering a faster way of reading imaging data on many spectral bands than typical existing systems. Moreover, by working with 20× thinner sections one would benefit from reduced contribution of tissue autofluorescence and similar undesired effects. This reduction of system noise would make barcoded single copy readout mode according to various embodiments described herein even more reliable.

In various embodiments, the systems taught herein can be used to readout single copy barcoded entities first and then be further imaged by cyclical staining with readout without single copy detection. For example, RNAs occur at low copies in the cell. In various embodiments, the imaging of different RNAs can be conducted in the single copy barcoded mode. While the proteins of different kinds are often more abundant, thus, in various embodiments, the majority of the proteins could be imaged in non-single copy mode. Yet, low abundance proteins can be tracked in single copy barcoded readout mode using various embodiments described herein.

In various embodiments, the optical setup can be configured to allocate some optical bands/channels to autofocusing engine. For example, the light of one or more channels can be used to generate a pattern or patterns on the sample. That light can then be read out by a photosensor in the same optical setup. In various embodiments, this information on the images is used to interpret if the system is in focus or even how much and which way the focusing needs to be adjusted to bring the images in focus.

The examples and embodiments disclosed herein will serve to further illustrate aspects of the invention without, at the same time, however, constituting any limitation thereof. On the contrary, it is to be clearly understood that resort may be had to various embodiments, modifications and equivalents thereof which, after reading the description herein, may suggest themselves to those skilled in the art without departing from the spirit of the invention. The examples and embodiments described herein may also make use of conventional procedures, unless otherwise stated. Some of the procedures are described herein for illustrative purposes.

### ILLUSTRATIVE ASPECTS

As used below, any reference to a series of aspects (e.g., “Aspects 1-4”) or non-enumerated group of aspects (e.g., “any previous or subsequent aspect”) is to be understood as a reference to each of the aspects identified disjunctively (e.g., “Aspects 1-4” is to be understood as “Aspects 1, 2, 3, or 4”).

Aspect 1 is a system comprising a sample holder; a light source positioned to direct illumination onto a sample in the sample holder; light collection optics positioned to receive output light from the sample, the light collection optics comprising a plurality of beamsplitters arranged to separate the output light from the sample into a plurality of detection channels spatially separated from one another, wherein different detection channels of the plurality of detection channels correspond to different wavelengths or wavelength bands of the output light; and a plurality of photosensors, each photosensor respectively positioned in optical communication with one or more beamsplitters to image output light from the sample at a corresponding detection channel onto the photosensor.

Aspect 2 is the system of any previous or subsequent aspect, wherein each photosensor is respectively positioned in optical communication with two or more beamsplitters to image output light from the sample at a corresponding detection channel wavelength onto the photosensor.

Aspect 3 is the system of any previous or subsequent aspect, wherein one beamsplitter of the plurality of beamsplitters is positioned in optical communication with all of the photosensors.

Aspect 4 is the system of any previous or subsequent aspect, wherein each photosensor has a corresponding optical path between the sample and the photosensor, wherein each optical path includes a same number of beamsplitters as at least one other optical path.

Aspect 5 is the system of any previous or subsequent aspect, wherein the output light collected from the sample corresponds to fluorescence generated by the sample.

Aspect 6 is the system of any previous or subsequent aspect, wherein the output light collected from the sample corresponds to light emitted by or transmitted by the sample.

Aspect 7 is the system of any previous or subsequent aspect, comprising or corresponding to a brightfield microscope.

Aspect 8 is the system of any previous or subsequent aspect, comprising or corresponding to a fluorescence microscope.

Aspect 9 is the system of any previous or subsequent aspect, wherein the light source comprises an unfiltered brightfield illumination source.

Aspect 10 is the system of any previous or subsequent aspect, wherein the light source comprises a white light illumination source or a broadband illumination source.

Aspect 11 is the system of any previous or subsequent aspect, wherein the light source is configured to provide brightfield illumination.

Aspect 12 is the system of any previous or subsequent aspect, wherein the illumination comprises brightfield illumination or white light.

Aspect 13 is the system of any previous or subsequent aspect, wherein the light source is configured for darkfield illumination.

Aspect 14 is the system of any previous or subsequent aspect, wherein the light source is configured to cycle the illumination between different wavelengths.

Aspect 15 is the system of any previous or subsequent aspect, wherein the light source is configured to cycle the illumination between at least 4 different wavelengths.

Aspect 16 is the system of any previous or subsequent aspect, wherein the different wavelengths are in a range of from 240 nm to 1000 nm.

Aspect 17 is the system of any previous or subsequent aspect, wherein the light source comprises a plurality of light emitting diodes or superluminescent light emitting diodes.

Aspect 18 is the system of any previous or subsequent aspect, wherein the plurality of light emitting diodes or superluminescent light emitting diodes are configured to sequentially illuminate the sample.

Aspect 19 is the system of any previous or subsequent aspect, wherein the plurality of light emitting diodes or superluminescent light emitting diodes produce at least 3 excitation channel wavelengths.

Aspect 20 is the system of any previous or subsequent aspect, wherein the light source comprises a plurality of lasers, wherein at least two lasers of the plurality of lasers can each alternate outputting illumination between at least two harmonics within a range of from 240 nm to 1000 nm.

Aspect 21 is the system of any previous or subsequent aspect, wherein the light source comprises a second plurality of beamsplitters configured to provide different wavelengths of illumination from one or more light emitting diodes, one or more superluminescent light emitting diodes, or one or more lasers.

Aspect 22 is the system of any previous or subsequent aspect, wherein the light source is configured for transillumination.

Aspect 23 is the system of any previous or subsequent aspect, wherein the light source and the light collection optics are arranged on opposite sides of the sample holder.

Aspect 24 is the system of any previous or subsequent aspect, wherein the light source is configured for epi-illumination.

Aspect 25 is the system of any previous or subsequent aspect, wherein the light source and the light collection optics are arranged on a same side of the sample holder.

Aspect 26 is the system of any previous or subsequent aspect, wherein the light source is configured to provide multi-spectral illumination in discrete bands.

Aspect 27 is the system of any previous or subsequent aspect, wherein the light source comprises a multi-notch filter.

Aspect 28 is the system of any previous or subsequent aspect, wherein wavelengths of illumination passed by the multi-notch filter are filtered out by the light collection optics.

Aspect 29 is the system of any previous or subsequent aspect, wherein the light source comprises a plurality of light emitting diodes, superluminescent diodes, or lasers configured to illuminate the sample simultaneously.

Aspect 30 is the system of any previous or subsequent aspect, wherein the light source provides illumination at an oblique angle to a surface of the sample in the sample holder.

Aspect 31 is the system of any previous or subsequent aspect, wherein the light source is positioned to direct the illumination toward the one or more beamsplitters of the plurality of beamsplitters.

Aspect 32 is the system of any previous or subsequent aspect, wherein the light source directs a spectrum of wavelengths onto the sample.

Aspect 33 is the system of any previous or subsequent aspect, wherein the light source comprises a grating or prism arranged to direct the spectrum of wavelengths onto the sample.

Aspect 34 is the system of any previous or subsequent aspect, wherein the light source comprises a broadband light source and a filter wheel for producing at least 3 excitation channel wavelengths.

Aspect 35 is the system of any previous or subsequent aspect, wherein the light collection optics further comprises a bandpass filter, wherein the bandpass filter is arranged between the sample holder and at least one of the 8 photosensors.

Aspect 36 is the system of any previous or subsequent aspect, wherein the bandpass filter is configured to filter the illumination from the light source.

Aspect 37 is the system of any previous or subsequent aspect, wherein a bandpass range of the bandpass filter is less than 20 nm.

Aspect 38 is the system of any previous or subsequent aspect, wherein the light collection optics further comprises at least 8 bandpass filters, wherein each bandpass filter is arranged between the plurality of beamsplitters and a corresponding photosensor of the at least 8 photosensors.

Aspect 39 is the system of any previous or subsequent aspect, wherein the light collection optics comprises a focusing lens, wherein the focusing lens is arranged between the plurality of beamsplitters and one of the at least 8 photosensors.

Aspect 40 is the system of any previous or subsequent aspect, wherein the focusing lens is a tube lens.

Aspect 41 is the system of any previous or subsequent aspect, wherein the light collection optics comprises at least 8 focusing lenses, wherein each focusing lens is arranged between the plurality of beamsplitters and a corresponding photosensor of the at least 8 photosensors.

Aspect 42 is the system of any previous or subsequent aspect, further comprising an objective lens positioned between the sample holder and the plurality of beamsplitters.

Aspect 43 is the system of any previous or subsequent aspect, wherein the objective lens exhibits a numerical aperture of 0.5 or greater.

Aspect 44 is the system of any previous or subsequent aspect, wherein the photosensors are configured to provide images of the sample with a pixel scale greater than a diffraction limit defined by at least a numerical aperture of the objective lens and the corresponding spatially separated detection channel wavelength.

Aspect 45 is the system of any previous or subsequent aspect, wherein at least one photosensor is configured to provide an image of the sample with a pixel scale about equal to the diffraction limit defined by at least the numerical aperture of the objective lens and the corresponding spatially separated detection channel wavelength.

Aspect 46 is the system of any previous or subsequent aspect, wherein the pixel scale is at least 1.2 times the diffraction limit.

Aspect 47 is the system of any previous or subsequent aspect, wherein a plurality of the photosensors are configured to detect a point source in the sample characterized by a dimension less than the diffraction limit onto less than 5 pixels of each the plurality of the photosensors.

Aspect 48 is the system of any previous or subsequent aspect, wherein a pixel pitch on at least one of the photosensors is larger than the diffraction limit times a magnification factor defined by at least the objective lens and the light collection optics.

Aspect 49 is the system of any previous or subsequent aspect, wherein less than 5 pixels of a plurality of the photosensors are allocated to map or sample a point spread function defined by at least a numerical aperture of the objective lens and the corresponding spatially separated detection channel wavelength.

Aspect 50 is the system of any previous or subsequent aspect, wherein a pixel scale of at least one of the images of the sample is at least 0.25 μm.

Aspect 51 is the system of any previous or subsequent aspect, wherein at least one photosensor is configured in a diffraction limited arrangement.

Aspect 52 is the system of any previous or subsequent aspect, wherein a field of view of the sample imaged by the light collection optics has one or more lateral dimensions of at least 0.25 mm.

Aspect 53 is the system of any previous or subsequent aspect, wherein the light collection optics comprises a spatial filter matched to a geometry of the light source, and wherein the spatial filter blocks illumination from the light source from being received at the at least 8 photosensors.

Aspect 54 is the system of any previous or subsequent aspect, wherein the spatial filter is an annular filter.

Aspect 55 is the system of any previous or subsequent aspect, wherein at least one beamsplitter of the plurality of beamsplitters directs illumination from the light source along an optical path toward the sample holder and directs at least a portion of the output light from the sample to at least one photosensor.

Aspect 56 is the system of any previous or subsequent aspect, wherein the at least one beamsplitter is a dichroic mirror.

Aspect 57 is the system of any previous or subsequent aspect, wherein the at least one beamsplitter is a metal coated mirror that directs at least 80% of the output light from the sample to the at least one photosensor.

Aspect 58 is the system of any previous or subsequent aspect, wherein the light source comprises an LED light source controllable to direct illumination to different beamsplitters of the plurality of beamsplitters.

Aspect 59 is the system of any previous or subsequent aspect, wherein the plurality of beamsplitters comprises an arrangement of beamsplitters with at least 3 levels of branching, wherein a branching level corresponds to a beamsplitter position to direct incident light to two other beamsplitters.

Aspect 60 is the system of any previous or subsequent aspect, wherein the plurality of beamsplitters comprises an arrangement of beamsplitters with at least 4 levels of branching.

Aspect 61 is the system of any previous or subsequent aspect, wherein the plurality of beamsplitters comprises an arrangement of beamsplitters with at least 5 levels of branching.

Aspect 62 is the system of any previous or subsequent aspect, wherein the plurality of beamsplitters are arranged so that different branching levels are spatially separated in 3 dimensions.

Aspect 63 is the system of any previous or subsequent aspect, wherein the plurality of beamsplitters comprises a hyperbranched tree of beamsplitters.

Aspect 64 is the system of any previous or subsequent aspect, wherein at least one beamsplitter of the plurality of beamsplitters comprises a prism.

Aspect 65 is the system of any previous or subsequent aspect, wherein the prism is configured to split incident light into three or more wavelengths.

Aspect 66 is the system of any previous or subsequent aspect, wherein the prism comprises at least two dichroic mirrors.

Aspect 67 is the system of any previous or subsequent aspect, wherein at least one beamsplitter of the plurality of beamsplitters comprises a dichroic mirror.

Aspect 68 is the system of any previous or subsequent aspect, wherein the dichroic mirror transitions from 10% to 90% transmission in less than 20 nm.

Aspect 69 is the system of any previous or subsequent aspect, wherein the dichroic mirror transitions from 10% to 90% transmission in less than 5 nm.

Aspect 70 is the system of any previous or subsequent aspect, wherein the dichroic mirror transitions from less than 3% transmission.

Aspect 71 is the system of any previous or subsequent aspect, wherein the dichroic mirror exhibits a cutoff wavelength of 900 nm or higher.

Aspect 72 is the system of any previous or subsequent aspect, wherein the dichroic mirror exhibits a cutoff wavelength of 1200 nm or higher.

Aspect 73 is the system of any previous or subsequent aspect, wherein at least one beamsplitter of the plurality of beamsplitters comprises a bandpass filter.

Aspect 74 is the system of any previous or subsequent aspect, wherein a plurality of the photosensors correspond to different sub-arrays of a common photosensor.

Aspect 75 is the system of any previous or subsequent aspect, configured to acquire images of the sample at each of the detection channel wavelengths simultaneously.

Aspect 76 is the system of any previous or subsequent aspect, wherein each photosensor is configured to acquire an image of the sample at the corresponding spatially separated detection channel wavelength at a same time as other photosensors.

Aspect 77 is the system of any previous or subsequent aspect, wherein one or more of the at least 8 photosensors comprise CMOS image sensors.

Aspect 78 is the system of any previous or subsequent aspect, wherein at least one CMOS image sensor exhibits a sub-electron readout level.

Aspect 79 is the system of any previous or subsequent aspect, wherein the sample holder comprises a microscope slide holder or is configured to retain a microscope slide.

Aspect 80 is the system of any previous or subsequent aspect, wherein the sample holder comprises a translation stage configured to adjust a position of the sample or the sample holder in at least two directions.

Aspect 81 is the system of any previous or subsequent aspect, wherein the translation stage is configured to position the sample in three directions, including a Z position that changes a distance between the sample or the sample holder and the light collection optics.

Aspect 82 is a method comprising exposing a sample to illumination from a light source; collecting output light from the sample using light collection optics positioned in optical communication with the sample; spatially separating the output light into at least 8 detection channel wavelengths using the light collection optics; imaging the output light spatially separated into at least 8 detection channel wavelengths onto at least 8 photosensors, wherein each photosensor is associated with a corresponding detection channel wavelength; and generating one or more images of the sample using one or more of the photosensors.

Aspect 83 is the method of any previous or subsequent aspect, wherein the light collection optics include a plurality of beamsplitters that spatially separate the output light into the at least 8 detection channel wavelengths.

Aspect 84 is the method of any previous or subsequent aspect, wherein the light collection optics include an objective lens having a numerical aperture greater than 0.7, wherein collecting the output light includes collecting the output light using the objective lens, and wherein at least one of the images has a pixel scale larger than a diffraction limit defined by at least the numerical aperture of the objective lens and a detection channel wavelength associated with the image.

Aspect 85 is the method of any previous or subsequent aspect, further comprising sectioning a sample volume by array tomography into a plurality of samples, wherein the method comprises generating one or more images of each of the plurality of samples by repeating the exposing, collecting, spatially separating, imaging, and generating steps one or more times for each of the plurality of samples.

Aspect 86 is the method of any previous or subsequent aspect, wherein the sample is resin embedded.

Aspect 87 is the method of any previous or subsequent aspect, further comprising staining the sample volume or one or more of the plurality of samples with labeled antibodies prior to exposing to illumination from the light source.

Aspect 88 is the method of any previous or subsequent aspect, wherein the plurality of samples comprise at least 20 sections of the sample volume.

Aspect 89 is the method of any previous aspect, wherein the plurality of samples are each less than 1 μm in thickness.

Aspect 90 is a system comprising a sample holder; a light source positioned in optical communication with the sample holder and configured to direct at least 3 excitation channel wavelengths onto a sample in the sample holder; an objective lens having a numerical aperture greater than 0.7 and positioned in optical communication with the sample holder; light collection optics positioned in optical communication with the objective lens and configured to spatially separate at least 8 emission channel wavelengths from the sample; and at least 8 photosensors positioned in optical communication with the light collection optics, each photosensor positioned to receive a corresponding spatially separated emission channel wavelength from the sample, wherein a plurality of the photosensors are configured to provide images of the sample with a pixel scale greater than a diffraction limit defined by at least the numerical aperture of the objective lens and the corresponding spatially separated emission channel wavelength.

Aspect 91 is the system of any previous or subsequent aspect, wherein at least one photosensor is configured to provide an image of the sample with a pixel scale about equal to the diffraction limit defined by at least the numerical aperture of the objective lens and the corresponding spatially separated emission channel wavelength.

Aspect 92 is the system of any previous or subsequent aspect, wherein the pixel scale is at least 1.2 times the diffraction limit.

Aspect 93 is the system of any previous or subsequent aspect, wherein a pixel scale of at least one of the images of the sample is at least 0.25 μm.

Aspect 94 is the system of any previous or subsequent aspect, wherein a pixel pitch on at least one of the plurality of photosensors is larger than the diffraction limit times a magnification factor defined by at least the objective lens and the light collection optics.

Aspect 95 is the system of any previous or subsequent aspect, wherein less than 5 pixels of a plurality of the photosensors are allocated to map or sample a point spread function defined by at least the numerical aperture of the objective lens and the corresponding spatially separated emission channel wavelength.

Aspect 96 is the system of any previous or subsequent aspect, wherein a plurality of the photosensors are configured to detect a point source in the sample characterized by a dimension less than the diffraction limit onto less than 5 pixels of each the plurality of the photosensors.

Aspect 97 is the system of any previous or subsequent aspect, wherein at least one photosensor is configured in a diffraction limited arrangement.

Aspect 98 is the system of any previous or subsequent aspect, wherein the light collection optics comprises at least one beamsplitter and wherein the light source is in optical communication with the at least one beamsplitter.

Aspect 99 is the system of any previous or subsequent aspect, wherein the at least one beamsplitter is a dichroic mirror.

Aspect 100 is the system of any previous or subsequent aspect, wherein the light collection optics comprises a plurality of beamsplitters arranged to spatially separate output light from the sample into the at least 8 emission channel wavelengths.

Aspect 101 is the system of any previous or subsequent aspect, wherein the light collection optics are configured to spatially separate at least 16 emission channel wavelengths from the sample and wherein the system comprises at least 16 photosensors.

Aspect 102 is the system of any previous or subsequent aspect, wherein the light collection optics comprises an arrangement of a plurality of beamsplitters that spatially separate the at least 8 emission channel wavelengths from the sample.

Aspect 103 is the system of any previous or subsequent aspect, wherein the plurality of beamsplitters comprises at least 2 beamsplitters between the objective lens and each photosensor.

Aspect 104 is the system of any previous or subsequent aspect, wherein the plurality of beamsplitters comprises at least 2 levels of branching, wherein a branching level corresponds to a beamsplitter position to direct incident light to two other beamsplitters.

Aspect 105 is the system of any previous or subsequent aspect, wherein the plurality of beamsplitters comprises at least 3 levels of branching.

Aspect 106 is the system of any previous or subsequent aspect, wherein the plurality of beamsplitters comprises at least 4 levels of branching.

Aspect 107 is the system of any previous or subsequent aspect, wherein the plurality of beamsplitters comprises at least 5 levels of branching.

Aspect 108 is the system of any previous or subsequent aspect, wherein the plurality of beamsplitters are arranged so that different branching levels are spatially separated in 3 dimensions.

Aspect 109 is the system of any previous or subsequent aspect, wherein the plurality of beamsplitters comprises a hyperbranched tree of beamsplitters.

Aspect 110 is the system of any previous or subsequent aspect, wherein at least one beamsplitter of the plurality of beamsplitters comprises a prism.

Aspect 111 is the system of any previous or subsequent aspect, wherein the prism is configured to split incident light into three or more wavelengths.

Aspect 112 is the system of any previous or subsequent aspect, wherein the prism comprises at least two dichroic mirrors.

Aspect 113 is the system of any previous or subsequent aspect, wherein at least one beamsplitter of the plurality of beamsplitters comprises a dichroic mirror.

Aspect 114 is the system of any previous or subsequent aspect, wherein the dichroic mirror transitions from 10% to 90% transmission in less than 20 nm.

Aspect 115 is the system of any previous or subsequent aspect, wherein the dichroic mirror transitions from 10% to 90% transmission in less than 5 nm.

Aspect 116 is the system of any previous or subsequent aspect, wherein the dichroic mirror transitions from less than 3% transmission.

Aspect 117 is the system of any previous or subsequent aspect, wherein the dichroic mirror exhibits a cutoff wavelength of 900 nm or higher.

Aspect 118 is the system of any previous or subsequent aspect, wherein the dichroic mirror exhibits a cutoff wavelength of 1200 nm or higher.

Aspect 119 is the system of any previous or subsequent aspect, wherein at least one beamsplitter of the plurality of beamsplitters comprises a bandpass filter.

Aspect 120 is the system of any previous or subsequent aspect, wherein the light source is configured to cycle between the at least 3 excitation channel wavelengths.

Aspect 121 is the system of any previous or subsequent aspect, wherein the light source is configured to cycle between at least 4 different excitation channel wavelengths.

Aspect 122 is the system of any previous or subsequent aspect, wherein the different wavelengths are in a range of from 240 nm to 1000 nm.

Aspect 123 is the system of any previous or subsequent aspect, wherein the light source comprises a plurality of light emitting diodes or superluminescent diodes.

Aspect 124 is the system of any previous or subsequent aspect, wherein the plurality of light emitting diodes or superluminescent diodes are configured to sequentially illuminate the sample.

Aspect 125 is the system of any previous or subsequent aspect, wherein the light source comprises a plurality of lasers and wherein at least two lasers of the plurality of lasers can each alternate outputting illumination between at least two harmonics within a range of from 240 nm to 1000 nm.

Aspect 126 is the system of any previous or subsequent aspect, wherein the light source comprises a plurality of beamsplitters configured to provide different wavelengths of illumination from one or more LED light sources, one or more superluminescent LED light sources, or one or more lasers.

Aspect 127 is the system of any previous or subsequent aspect, wherein the light source is configured for transillumination.

Aspect 128 is the system of any previous or subsequent aspect, wherein the light source and the objective lens are arranged on opposite sides of the sample holder.

Aspect 129 is the system of any previous or subsequent aspect, wherein the light source is configured for epi-illumination.

Aspect 130 is the system of any previous or subsequent aspect, wherein the light source and the objective lens are arranged on a same side of the sample holder.

Aspect 131 is the system of any previous or subsequent aspect, wherein the light source comprises a multi-notch filter.

Aspect 132 is the system of any previous or subsequent aspect, wherein wavelengths of illumination passed by the multi-notch filter are filtered out by the light collection optics.

Aspect 133 is the system of any previous or subsequent aspect, wherein the light source comprises a plurality of light emitting diodes, superluminescent diodes, or lasers configured to illuminate the sample simultaneously.

Aspect 134 is the system of any previous or subsequent aspect, wherein the light source comprises a broadband light source and a filter wheel for producing the at least 3 excitation channel wavelengths.

Aspect 135 is the system of any previous or subsequent aspect, wherein a plurality of the photosensors correspond to different sub-arrays of a common photosensor.

Aspect 136 is the system of any previous or subsequent aspect, configured to acquire images of the sample at each of the emission channel wavelengths simultaneously.

Aspect 137 is the system of any previous or subsequent aspect, wherein each photosensor is configured to acquire an image of the sample at the corresponding spatially separated emission channel wavelength at a same time as other photosensors.

Aspect 138 is the system of any previous or subsequent aspect, wherein one or more of the at least 8 photosensors comprise CMOS image sensors.

Aspect 139 is the system of any previous or subsequent aspect, wherein at least one CMOS image sensor exhibits a sub-electron readout level.

Aspect 140 is the system of any previous or subsequent aspect, wherein the sample holder comprises a microscope slide holder or is configured to retain a microscope slide.

Aspect 141 is the system of any previous or subsequent aspect, wherein the sample holder comprises a translation stage configured to adjust a position of the sample or the sample holder in at least two directions.

Aspect 142 is the system of any previous aspect, wherein the translation stage is configured to position the sample in three directions, including a Z position that changes a distance between the sample or the sample holder and the light collection optics.

### REFERENCES

N. Hagen, M. Kudenov, “Review of snapshot spectral imaging technologies,” Optical Engineering 52 (9), 2013.
Morrison et al., Brightfield multiplex immunohistochemistry with multispectral imaging, Laboratory Investigation 100. pp. 1124-1136, 2020.
Gheiratmand et al., 2022, “Immuno Tomography (IT) and Imaging Mass Cytometry (IMC) for constructing spatially resolved, multiplexed 3D IMC data sets,” The Ocular Surface, 25, July 2022. pp. 49-54, DOI: 10.1016/j.jtos.2022.04.008
U.S. Pat. No. 5,900,942 and 10.816.473.

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference.

References cited herein are incorporated by reference herein in their entirety to indicate the state of the art, in some cases as of their filing date, and it is intended that this information can be employed herein, if needed, to exclude (for example, to disclaim) specific embodiments that are in the prior art.

When a group of substituents is disclosed herein, it is understood that all individual members of those groups and all subgroups and classes that can be formed using the substituents are disclosed separately. When a Markush group or other grouping is used herein, all individual members of the group and all combinations and subcombinations possible of the group are intended to be individually included in the disclosure. As used herein, “and/or” means that one, all, or any combination of items in a list separated by “and/or” are included in the list; for example “1, 2 and/or 3” is equivalent to “‘1’ or ‘2’ or ‘3’ or ‘1 and 2’ or ‘1 and 3’ or ‘2 and 3’ or ‘1, 2, and 3’”.

Every formulation or combination of components described or exemplified can be used to practice the invention, unless otherwise stated. Specific names of materials are intended to be exemplary, as it is known that one of ordinary skill in the art can name the same material differently. It will be appreciated that methods, device elements, starting materials, and synthetic methods other than those specifically exemplified can be employed in the practice of the invention without resort to undue experimentation. All art-known functional equivalents, of any such methods, device elements, starting materials, and synthetic methods are intended to be included in this invention. Whenever a range is given in the specification, for example, a wavelength range, a time range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein. “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by various embodiments, examples, and optional features, modification and variation of the concepts herein disclosed may be resorted to by those skilled in the art, and that such modifications and variations are considered to be within the scope of this invention as defined by the appended claims.

What is claimed is:

1. A system comprising:
a sample holder;
a light source positioned to direct illumination onto a sample in the sample holder;
light collection optics positioned to receive output light from the sample, the light collection optics comprising a plurality of beamsplitters arranged to separate the output light from the sample into a plurality of detection channels spatially separated from one another, wherein different detection channels of the plurality of detection channels correspond to different wavelengths or wavelength bands of the output light; and
a plurality of photosensors, each photosensor respectively positioned in optical communication with one or more beamsplitters to image output light from the sample at a corresponding detection channel onto the photosensor.

2. The system of claim 1, wherein each photosensor is respectively positioned in optical communication with two or more beamsplitters to image output light from the sample at a corresponding detection channel wavelength onto the photosensor.

3. The system of claim 1, wherein one beamsplitter of the plurality of beamsplitters is positioned in optical communication with all of the photosensors.

4. The system of claim 1, wherein each photosensor has a corresponding optical path between the sample and the photosensor, wherein each optical path includes a same number of beamsplitters as at least one other optical path.

5. The system of claim 1, wherein the illumination comprises brightfield illumination or white light.

6. The system of claim 1, wherein the light source is configured for darkfield illumination.

7. The system of claim 1, wherein the light source is configured to cycle the illumination between different wavelengths.

8. The system of claim 7, wherein the different wavelengths are in a range of from 240 nm to 1000 nm.

9. The system of claim 1, wherein the light source comprises a plurality of light emitting diodes or superluminescent light emitting diodes.

10. The system of claim 9, wherein the plurality of light emitting diodes or superluminescent light emitting diodes produce at least 3 excitation channel wavelengths.

11. The system of claim 1, wherein the light source comprises a second plurality of beamsplitters configured to provide different wavelengths of illumination from one or more light emitting diodes, one or more superluminescent light emitting diodes, or one or more lasers.

12. The system of claim 1, wherein the light source is configured to provide multi-spectral illumination in discrete bands.

13. The system of claim 1, wherein the light source directs a spectrum of wavelengths onto the sample.

14. The system of claim 13, wherein the light source comprises a grating or prism arranged to direct the spectrum of wavelengths onto the sample.

15. The system of claim 1, wherein the light collection optics further comprises a bandpass filter, wherein the bandpass filter is arranged between the sample holder and at least one of the 8 photosensors.

16. The system of claim 1, wherein the light collection optics further comprises at least 8 bandpass filters, wherein each bandpass filter is arranged between the plurality of beamsplitters and a corresponding photosensor of the at least 8 photosensors.

17. The system of claim 1, wherein the light collection optics comprises a focusing lens, wherein the focusing lens is arranged between the plurality of beamsplitters and one of the at least 8 photosensors.

18. The system of claim 1, further comprising an objective lens positioned between the sample holder and the plurality of beamsplitters.

19. The system of claim 1, wherein at least one beamsplitter of the plurality of beamsplitters directs illumination from the light source along an optical path toward the sample holder and directs at least a portion of the output light from the sample to at least one photosensor.

20. The system of claim 1, wherein the plurality of beamsplitters comprises an arrangement of beamsplitters with at least 3 levels of branching, wherein a branching level corresponds to a beamsplitter position to direct incident light to two other beamsplitters.

21. The system of claim 1, wherein a plurality of the photosensors correspond to different sub-arrays of a common photosensor.

22. The system of claim 1, configured to acquire images of the sample at each of the detection channel wavelengths simultaneously.

23. A system comprising:
a sample holder;
a light source positioned in optical communication with the sample holder and configured to direct at least 3 excitation channel wavelengths onto a sample in the sample holder;
an objective lens having a numerical aperture greater than 0.7 and positioned in optical communication with the sample holder;
light collection optics positioned in optical communication with the objective lens and configured to spatially separate at least 8 emission channel wavelengths from the sample; and
at least 8 photosensors positioned in optical communication with the light collection optics, each photosensor positioned to receive a corresponding spatially separated emission channel wavelength from the sample, wherein a plurality of the photosensors are configured to provide images of the sample with a pixel scale greater than a diffraction limit defined by at least the numerical aperture of the objective lens and the corresponding spatially separated emission channel wavelength.

24. The system of claim 23, wherein at least one photosensor is configured to provide an image of the sample with a pixel scale about equal to the diffraction limit defined by at least the numerical aperture of the objective lens and the corresponding spatially separated emission channel wavelength.

25. The system of claim 24, wherein the pixel scale is at least 1.2 times the diffraction limit.

26. The system of claim 23, wherein at least one photosensor is configured in a diffraction limited arrangement.

27. The system of claim 23, wherein the light collection optics comprises at least one beamsplitter and wherein the light source is in optical communication with the at least one beamsplitter.

28. The system of claim 23, wherein the light collection optics comprises a plurality of beamsplitters arranged to spatially separate output light from the sample into the at least 8 emission channel wavelengths.

29. The system of claim 28, wherein the plurality of beamsplitters comprises at least 2 beamsplitters between the objective lens and each photosensor.

30. The system of claim 28, wherein the plurality of beamsplitters comprises at least 2 levels of branching, wherein a branching level corresponds to a beamsplitter positioned to direct incident light to two other beamsplitters.

31. The system of claim 30, wherein the plurality of beamsplitters comprises at least 3 levels of branching.
